(19) United States
(12) Patent Application Publication
(10) Pub. No.: US 2026/0186868 A1
(43) Pub. Date: Jul. 2, 2026

(54) SHARING SYSTEM FOR COLLABORATION AND COMMUNICATION PLATFORMS

(71) Applicant: Microsoft Technology Licensing, LLC, Redmond, WA (US)

(72) Inventors: Mengjia LUO, Seattle, WA (US); Vikramjit Singh CHUG, Bellevue, WA (US); Manasi SHARMA, Bothell, WA (US); Siddharth UPPAL, Redmond, WA (US); Manpratap Singh SURI, Bellevue, WA (US); Kellan David CORBITT, Issaquah, WA (US); Ashley Marie ROCHA, Kirkland, WA (US); Kanchan KAUR, Redmond, WA (US)

(73) Assignee: Microsoft Technology Licensing, LLC, Redmond, WA (US)

(21) Appl. No.: 19/003,295

(22) Filed: Dec. 27, 2024

(51) Int. Cl. G06F 9/54; G06F 9/451

(52) U.S. Cl. CPC G06F 9/541; G06F 9/451

(57) ABSTRACT

A collaboration and communication platform provides share controls which can be embedded in application content and activated to share the application content to online collaborations from outside of the meeting stage context and that enable the sharing protocol used to share the app content to be specified by the developer of the app content. The platform extends app manifests and application programming interfaces (APIs) to provide (i) diverse entry points via which content sharing can be activated from outside of the meeting stage context and (ii) multiple mechanisms for specifying the sharing protocol for the platform to use in sharing the content to an online collaboration.

### BACKGROUND

Previously known collaboration and sharing systems had limited options for selecting content to share, and limited options for controlling how content was shared. For example, in previously known collaboration systems, content could not be shared to the meeting stage from contexts external to the meeting stage, such as the side panel, tabs, and windows of the collaboration client. As a result, previously known methods of sharing content required that a share control be included within the context of the meeting stage to enable searching for and/or navigating to content to share from within the meeting stage context. Another method that has been used to share content to an online collaboration requires integration with the operating system so that share controls can be added to thumbnail previews of open applications on the taskbar. These methods of selecting and sharing content typically required frequent context switching as well as complex and/or non-intuitive search mechanisms to identify and select the content to share. In addition, previously known collaboration systems selected the sharing protocol to use to share content based on factors, such as content type and sharing context. There were not any mechanisms to allow developers to specify the sharing protocol to use to share app content in these systems.

Hence, what is needed are mechanisms for enabling content sharing to be activated form various contexts outside of the meeting stage context and mechanism for enabling the sharing protocol used to share the content to be specified programmatically by developers.

### SUMMARY

In one general aspect, the instant disclosure presents a data processing system for sharing application content from a third-party application to an online collaboration hosted by a collaboration and communication platform. The data processing system includes a processor and a memory in communication with the processor. The memory stores executable instructions that, when executed by the processor alone or in combination with other processors, cause the data processing system to perform multiple functions. The functions include rendering an application page in a user interface (UI) of the third-party application on a display device, the application page including the application content to share, the third-party application being associated with a first user; providing at least one share control in the application page, the at least one share control being programmed to generate an application programming interface (API) call to an API of the collaboration and communication platform, the API call specifying (i) the application content to share to the online collaboration and (ii) a sharing protocol for the collaboration and communication platform to use to share the application content to the online collaboration, the sharing protocol being one of a plurality of different sharing protocols enabled by the collaboration and communication platform, each of the sharing protocols defining a format for how the collaboration and communication platform presents shared content on devices of users attending online collaborations; and in response to detecting an activation of the at least one share control in the application page: automatically identifying the API call programmed in the at least one share control; and causing the collaboration and communication platform to (i) retrieve the application content and (ii) share the retrieved application content to the online collaboration according to the specified sharing protocol by transmitting the API call to the collaboration and communication platform.

In yet another general aspect, the instant disclosure presents a method for sharing application content from a third-party application to an online collaboration hosted by a collaboration and communication platform. The method includes rendering an application page in a user interface (UI) of the third-party application on a display device, the application page including the application content to share, the third-party application being associated with a first user; providing at least one share control in the application page, the at least one share control being programmed to generate an application programming interface (API) call to an API of the collaboration and communication platform, the API call specifying (i) the application content to share to the online collaboration and (ii) a sharing protocol for the collaboration and communication platform to use to share the application content to the online collaboration, the sharing protocol being one of a plurality of different sharing protocols enabled by the collaboration and communication platform, each of the sharing protocols defining a format for how the collaboration and communication platform presents shared content on devices of users attending online collaborations; and in response to detecting an activation of the at least one share control in the application page: automatically identifying the API call programmed in the at least one share control; and causing the collaboration and communication platform to (i) retrieve the application content and (ii) share the retrieved application content to the online collaboration according to the specified sharing protocol by transmitting the API call to the collaboration and communication platform.

In a further general aspect, the instant application describes a non-transitory computer readable medium on which are stored instructions that when executed cause a programmable device to perform functions of rendering an application page in a user interface (UI) of a third-party application on a display device, the application page including application content to share to an online collaboration hosted by a collaboration and communication platform, the third-party application being associated with a first user; providing at least one share control in the application page, the at least one share control being programmed to generate an application programming interface (API) call to an API of the collaboration and communication platform, the API call specifying (i) the application content to share to the online collaboration and (ii) a sharing protocol for the collaboration and communication platform to use to share the application content to the online collaboration, the sharing protocol being one of a plurality of different sharing protocols enabled by the collaboration and communication platform, each of the sharing protocols defining a format for how the collaboration and communication platform presents shared content on devices of users attending online collaborations; and in response to detecting an activation of the at least one share control in the application page: automatically identifying the API call programmed in the at least one share control; and causing the collaboration and communication platform to (i) retrieve the application content and (ii) share the retrieved application content to the online collaboration according to the specified sharing protocol by transmitting the API call to the collaboration and communication platform.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram showing the components of a collaboration and communication platform according to this disclosure.

FIG. 1B depicts an example computing environment in the collaboration and communication platform of FIG. 1A is implemented.

FIG. 2A depicts a diagram of the meeting window of a collaboration client showing the gallery of participants and the side panel.

FIG. 2B depicts a diagram of the meeting window of the collaboration client showing the gallery and the meeting stage.

FIG. 2C depicts a diagram of the meeting window of the collaboration client showing the share tray.

FIG. 3 depicts a diagram of the main window of the collaboration client.

FIGS. 4A and 4B shows example context properties to use in app manifests for applications which enable the sharing protocol for sharing content from the applications to be specified.

FIG. 5 shows a block diagram of a sharing system including in accordance with this disclosure.

FIG. 6 depicts a diagram of a third-party application and a collaboration client which shows how multiple share controls can be embedded in application content and used to share content items in the application content to online collaborations.

FIGS. 7A and 7B show example API calls which share controls can be programmed to generate and which can be used to activate sharing of content and specify the non-interactive sharing protocol and the interactive sharing protocol, respectively, as the sharing protocol to use to share the content.

FIG. 8 shows an example configuration for an authorization property of an app manifest which enables resource-specific consent (RSC) permissions to be obtained for an application.

FIG. 9 shows a block diagram of a sharing system that utilizes share controls to generate API calls which can activate sharing, specify the content to be shared, and specify the sharing protocol to use to share the content.

FIG. 10 is a block diagram showing how interactive sharing is implemented for a collaboration and communication platform.

FIG. 11 is a block diagram showing how non-interactive sharing is implemented for a collaboration and communication platform.

FIG. 12 depicts a flowchart of an example method 1200 for sharing application content from a third-party application to an online collaboration hosted by a collaboration and communication platform.

FIG. 13 is a block diagram showing an example software architecture, various portions of which may be used in conjunction with various hardware architectures herein described, which may implement any of the described features.

FIG. 14 is a block diagram showing components of an example machine configured to read instructions from a machine-readable medium and perform any of the features described herein.

### DETAILED DESCRIPTION

Previously known collaboration systems and platforms had limited options for selecting content to share, and limited options for controlling how content was shared (i.e., interactively or non-interactively) to an online collaboration. For example, previously known collaboration systems were not capable of sharing content to an online collaboration from outside the context of the online collaboration. To enable sharing to an online collaboration, previously known sharing systems would typically have to activate sharing from within the context of the online collaboration, i.e., from within the meeting window of the client application. For example, to share content to an online meeting, a user would have to activate a share control provided in a toolbar, tray, menu, or other type of user interface control in the meeting window. Once the share control was activated, a menu would open in the meeting window having a list of options for selecting, searching for, and/or navigating to content to share with the online collaboration. Another method used to share content to an online collaboration requires integration with the operating system of a computing device so that share controls can be added to thumbnail previews of open applications on the operating system taskbar. Sharing is activated in this case by hovering the mouse cursor over the thumbnail previews until the application window having the content to share is identified. The share control added to the thumbnail preview can then be activated to initiate sharing of the application content to an online collaboration.

While these methods were capable of sharing content to online collaborations, these methods required frequent context switching between the context of the application having the content to share, the context of the meeting stage where the content is shared, the context of the share control used to activate sharing (e.g., the meeting stage context or the operating system (i.e., the taskbar) context, and/or the context of search and navigation tools used to find the content to be shared once sharing is activated. These methods of selecting and sharing content also relied on complex and/or non-intuitive search mechanisms to identify and select the content to share. For example, navigating through menus and lists to identify content to share can be difficult if the file names associated with HTML documents, style sheets, and the like are not known. Similarly, hovering over thumbnail previews to identify content to share can be difficult because thumbnail previews may be difficult to distinguish due to their small size. In addition, there may be many open documents and application windows for which thumbnail previews are generated for the taskbar so hovering over one thumbnail preview after another to identify the content to share can be a time consuming and frustrating task.

In addition to the limited ability to activate sharing from outside the context of the meeting stage, previously known sharing systems provided no mechanisms to enable developers to specify sharing protocols to use to share their content to online collaborations. Some systems enabled different sharing protocols to be used to share content by providing two different buttons in the user interface of the sharing system. One button was used to share content to a meeting in an interactive manner while another button was used to share content to a meeting in a non-interactive manner. However, this method of enabling different sharing protocols is controlled and implemented by the system and provides no mechanisms for enabling sharing protocols to be specified by developers.

The difficulties associated with enabling content to be shared to an online collaboration from outside the context of the meeting stage where the online collaboration is presented and the difficulties associated with providing mechanisms which enable developers to specify the sharing protocol to use to share content from their apps are technical problems in the technical field of collaboration and communication systems. These technical problems require technical solutions that enable content to be shared from various contexts which are outside of the meeting stage context and that enable greater control and provide new mechanisms which enable the sharing protocol that is used to share content to be specified by developers.

To address the technical problems associated with previously known content sharing system and methods, the present disclosure provides technical solutions in the form of mechanisms and extensions to collaboration and communication platforms which enable share controls to be embedded in app content and activated to share the app content to online collaborations from outside of the context of the meeting stage and that enable the sharing protocol used to share the app content to be specified by the developer of the app content. These mechanisms include extensions of the app manifests used to integrate third-party applications into the collaboration and communication platform to include a property that can be configured to indicate the sharing protocol to be used to share app content to online collaborations. The mechanisms also include extensions of the platforms application programming interfaces (APIs) to provide a sharing API that defines API calls that can be used to activate sharing of content and to specify the sharing protocol to use to share the content. The APIs may also specify ways for API calls to be used to identify specific parts of applications (e.g., content items) to share to an online collaboration.

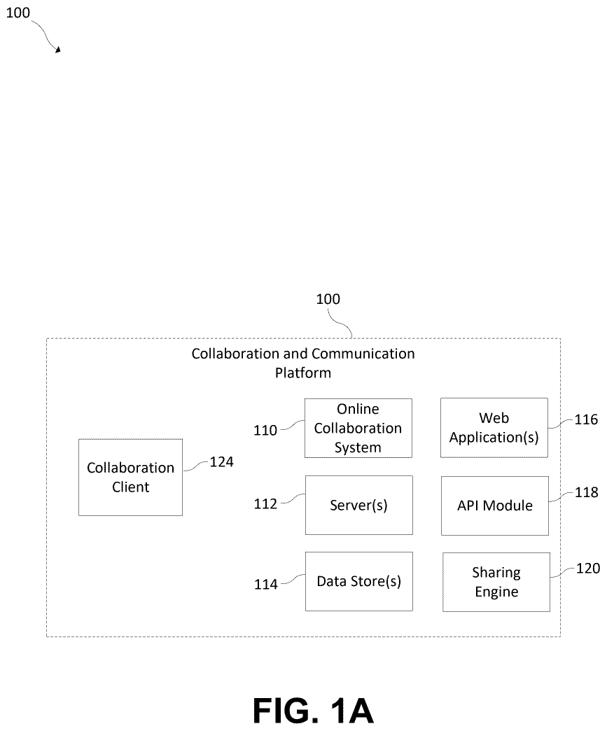

FIG. 1A is a diagram of an example implementation of a collaboration and communication platform 100 showing the components of the platform, and FIG. 1B shows an example computing environment 101 in which the platform of FIG. 1A is implemented. Referring to FIG. 1A, the collaboration and communication platform 100 provides an online collaboration system 110 that enables users to set up, join, and host online collaborations, such as meetings, video conferences, audio calls, classes, presentations, chats, and the like. The collaboration and communication platform 100 provides infrastructure components, such as servers 112 and data stores 114, for hosting collaborations and providing computational resources for implementing the features and functionality of the online collaboration system 110 and the collaboration and communication platform 102. Servers 112 may be any physical or virtual computing system, device, or collection thereof, such as, a web server, rack server, blade server, virtual machine server, or tower server, as well as any other type of computing system. In various implementations, servers 112 are implemented in a data center, a virtual data center, or some other suitable facility. Servers 112 execute one or more software applications, modules, components, or collection thereof capable of providing an online collaboration system to clients. Data store(s) 114 include any suitable type, number, and/or configuration of digital repositories, such as cache systems, document stores, databases, file systems, and the like, for collecting, storing, managing, and retrieving data in connection with the online collaboration system. Data can include program code, instructions, user data, collaboration data (e.g., meeting schedules, calendar information, project data, etc.), and the like.

The platform 100 includes a collaboration client application 124 (referred to herein as a collaboration client) which enables users to connect to the collaboration and communication platform 100 and access the functionality provided by the platform 100. In various implementations, the collaboration and communication platform 100 provides one or more web applications 116 which enable features of the collaboration and communication platform 100 to be accessed via a web browser. In addition, the collaboration and communication platform 100 includes an application programming interface (API) module 118 that defines one or more APIs via which third-party applications can interact with and access features of the platform 100. An API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture. APIs enable third-party applications to use the functions, methods, procedures, data structures, classes, and/or other services provided by the platform 100.

The collaboration and communication platform 100 provides a number of features that can promote engagement and enhance experiences with online collaborations. One such feature is content sharing. The collaboration and communication platform 100 includes a sharing engine 120 which enables content, such as documents, audio/video files, applications, webpages, screen shares (e.g., desktop, window, application, etc.), and the like, to be shared to online collaborations both interactively and non-interactively. Interactive sharing refers to the ability for participants of an online collaboration, such as a meeting, to engage and collaborate dynamically with shared content, such as documents, presentations, or whiteboards, during the meeting. Interactive sharing allows multiple users to interact with or contribute to the shared content in real time. Non-interactive sharing refers to the type of content sharing where meeting participants can only view what is being shared by the presenter without directly interacting with it. The presenter shares a view of their entire screen or a specific window and has full control over the content. The other participants are limited to observing the shared screen or window. The sharing engine 120 utilizes predefined sharing protocols for implementing interactive and non-interactive sharing for the collaboration and communication platform. A sharing protocol refers to the underlying mechanisms, processes, and rules used which enables different types of content to be selected, retrieved, distributed, and presented to participants of an online collaboration. A more detailed description of how interactive and non-interactive sharing is implemented is provided below.

Referring to FIG. 1B, the computing environment 101 includes a collaboration and communication service 102, computing devices 104, and web applications 106 which communicate with each other via a network 108. The network 108 includes one or more wired, wireless, and/or a combination of wired and wireless networks. The network 108 may include one or more local area networks (LAN), wide area networks (WAN) (e.g., the Internet), public networks, private networks, virtual networks, mesh networks, peer-to-peer networks, and/or other interconnected data paths across which multiple devices may communicate. In embodiments, the network 108 is coupled to or includes portions of a telecommunications network for sending data in a variety of different communication protocols. In some implementations, the network 108 includes Bluetooth® communication networks or a cellular communications network for sending and receiving data including via short messaging service (SMS), multimedia messaging service (MMS), hypertext transfer protocol (HTTP), direct data connection, WAP, email, and the like.

In FIG. 1B, the collaboration and communication platform is implemented by the collaboration and communication service 102 which provides collaboration and communication features to collaboration clients 124 which are being executed on the computing devices. Computing devices 104 are any type of electronic device that can store, process, and retrieve data, execute programs, run applications, and the like. Computing devices 104 can be personal computers, desktop computers, laptops, smartphones, tablets, smart watches, wearable technology, gaming consoles, smart televisions, and the like. Each computing device 104 includes at least one third-party application 122 which is capable of assisting users in performing one or more tasks, such as viewing, creating, and/or editing content (e.g., text, images, audio, video, documents, web pages, software, etc.), communicating and collaborating (e.g., email, chat, messaging, audio and video communications, online meetings, etc.), and the like. In some implementations, the third-party application 122 is a local application which is installed and executed on the computing device 104. In other implementations, the third-party application 122 comprises a web browser which can access web pages and run third-party web applications, such as third-party web applications 106. Third-party web applications 106 are software applications which are run on remote servers and are accessed via web browsers over the Internet. Examples of web applications include content creating/editing applications (e.g., word processors, presentation applications, etc.), productivity applications (e.g., calendar, task management, etc.), communication applications (e.g., messaging, email, chat, etc.), online shopping, social networking, banking, and the like. A web application can be any website that performs tasks and actions or provides services beyond just serving static information.

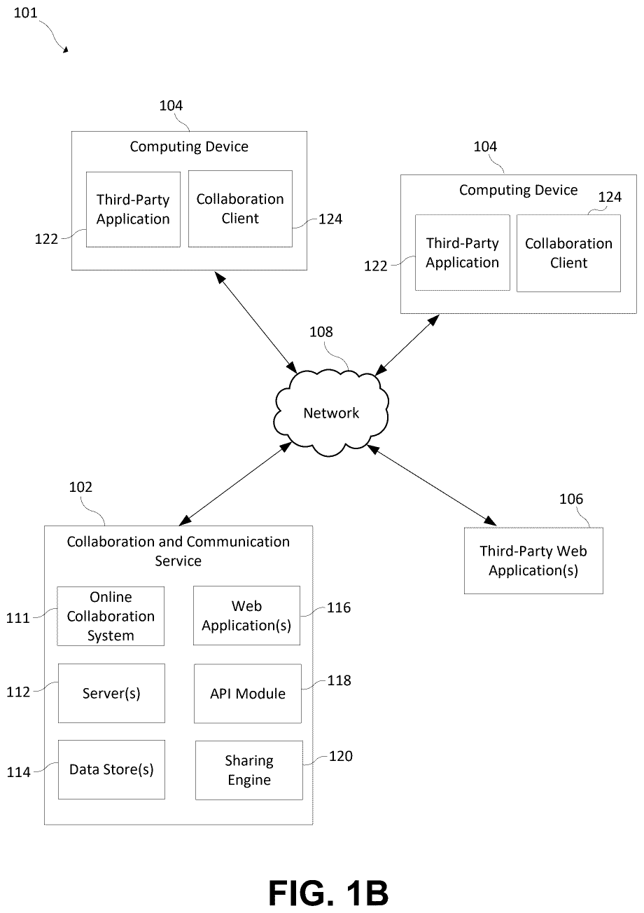

The collaboration client 124 provides a user interface that enables users to set up, schedule, join, and host online collaborations. An example implementation of a meeting user interface (UI) 200 for connecting to and participating in online collaborations is shown in FIGS. 2A, 2B, and 2C. The meeting UI 200 includes a meeting window 202 in which a gallery 204, a meeting stage 206, and a side panel 208 can be shown. The gallery 204 shows the participants of an active online collaboration. Participants are represented in the gallery 204 by participant tiles 210. During online collaborations, tiles 210 can show video feeds of participants who have video enabled. Otherwise, tiles 210 can show a participant's name and an image, such as a preselected avatar or generic background image. Participant tiles 210 are arranged in a grid in the gallery. Participants may also provide real-time audio feed which enables participants to see and hear each other during the online collaboration.

The collaboration and communication platform 102 enables content to be shared with online collaborations (explained in more detail below). The meeting window 202 can include a gallery 204 which shows participant feeds 210. When there is no content being shared to the online collaboration, only the gallery 204 is shown, as can be seen in FIG. 2A. Shared content 212 is presented in the meeting stage 206 of the meeting UI 200, as shown in FIG. 2B. When content 212 is shared to the meeting stage 202, the shared application content 206 is displayed such that it covers a major part of the meeting stage 202 to make the content easier to see for viewers. As seen in FIG. 2B, the gallery 204 of participant feeds 204 may be moved to the edge of the meeting window 202 (e.g., along the top edge in FIG. 2B) or hidden from view. The side panel 208 is arranged along one side of the gallery 204 and the meeting stage 206. The side panel 208 provides a separate context which enables users to perform various tasks, such as searching for content to share with the collaboration. As shown in FIG. 2C, the meeting UI 200 also includes a share tray control 216 which, when activated (e.g., clicked on), causes a share tray 218 to be shown. The share tray 218 includes various controls for selecting a screen, a window, an application, and/or a document to be shared to the collaboration and presented on the meeting stage 206.

Returning to FIG. 1B, the collaboration and communication service 102 enables third-party applications (i.e., applications developed by individuals, groups, or organizations that are not affiliated with the platform) to be integrated into the collaboration and communication platform 100 and accessed using a collaboration client 124. Third-party applications (or “apps”) can be used to add to and/or enhance the features and/or capabilities provided by the platform 102. Third-party apps correspond to webpages which can be created using HTML, CSS (Cascading Style Sheets), JavaScript, and the like. Each app has a web address, such as a uniform resource locator (URL) address, which specifies the location of the app's content. The collaboration and communication platform 102 provides tools to facilitate the creation and integration of third-party apps into the platform 102, such as application programming interfaces (APIs), software development kits (SDKs), templates, and the like. App manifests are used to facilitate the integration of third-party applications into the collaboration and communication platform. An app manifest is a file that defines the implementation details of the application, such as name and description, icon(s), URL, capabilities, permissions, contexts, metadata, and the like. In various implementations, the app manifest is a JavaScript Object Notation (JSON) file though any suitable file type or data structure capable of recording and conveying application details may be used. The collaboration and communication platform 102 stores the app manifests for each app integrated into the platform in a data store 114.

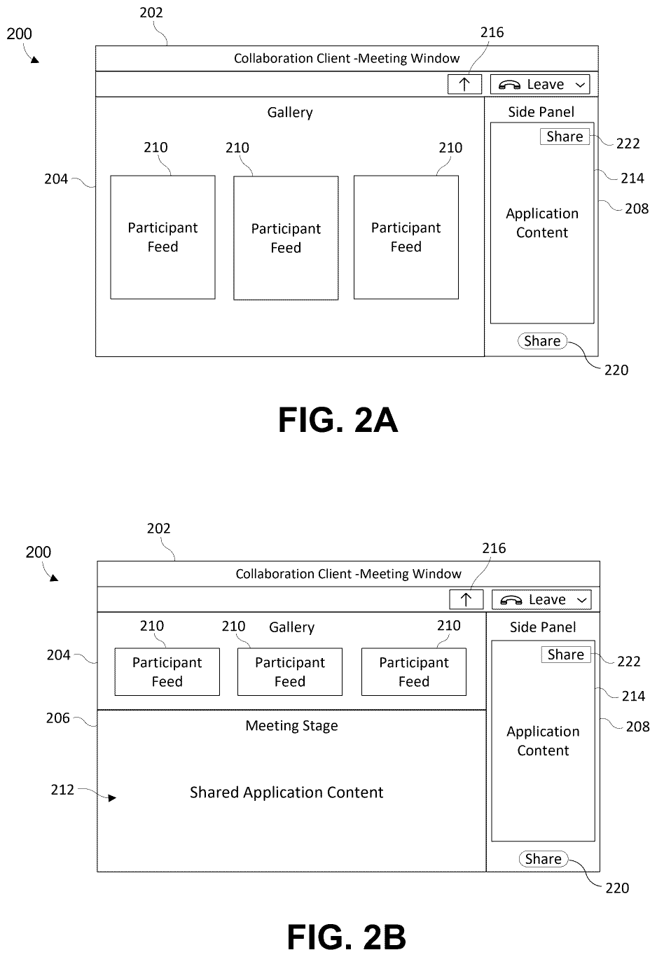

App content can be loaded into various contexts provided by the user interface of the collaboration client. A context corresponds to an interface element, such a frame, window, panel, or the like in which app content can be loaded and interacted with independently from content loaded in contexts of the collaboration client. For example, referring to FIG. 3, the user interface 300 of a collaboration client can include a main window context 302 and a side panel context 304 which can each load different apps. Collaboration clients may also include a tab context (not shown) and a new window context (not shown) which correspond substantially to the main window context. Apps are hosted in secure interface elements, such as iFrames, within the contexts of the collaboration client. IFrames enable apps to be displayed directly inside the interface of the collaboration client which allows the collaboration client to control the display and interaction with the embedded application which in turn helps to provide a seamless user experience without having to switch between different applications.

As noted above, previously known collaboration systems had limited options for selecting content to share, and limited options for controlling how content was shared (i.e., interactively or non-interactively) to an online collaboration. For example, in previously known collaboration systems, content could not be shared to the meeting stage from contexts external to the meeting stage, such as the side panel, tabs, and windows of the collaboration client. As a result, previously known methods of sharing content required that a share control be included in the context of the meeting stage to enable searching for and/or navigating to content to share from within the meeting stage context. Another method that has been used to share content to an online collaboration requires integration with the operating system so that share controls can be added to thumbnail previews of open applications on the taskbar. These methods of selecting and sharing content typically required frequent context switching as well as complex and/or non-intuitive search mechanisms to identify and select the content to share. In addition, previously known collaboration systems selected the sharing protocol to use to share content based on factors, such as content type and sharing context. There were not any mechanisms to allow developers to specify the sharing protocol to use to share app content in these systems.

To address the limitations of previously known collaboration systems discussed above, the collaboration and communication platform 102 according to this disclosure provides multiple entry points for selecting content and sharing the content to an online collaboration. An entry point in this case refers to a user interface control (referred to herein as a “share control”) which can be interacted with to cause content to be shared to an online collaboration. Share controls may comprise an HTML element, such as a button or link, which can be added to the HTML code used to define the structure and layout of the user interface of the collaboration client or added to the HTML code which defines the layout of application pages loaded into iFrames in the contexts of the user interface for the collaboration client. Share controls can be added to the side panel, main window, tabs, and new window contexts of the collaboration client. FIG. 3 shows how share controls 302 can be embedded into the user interface contexts of a collaboration client 300, such as the main window 304 and side panel 306. Share controls 308 can also be embedded in the app content which is loaded into the user interface contexts. The share controls 302, 308 enables content to be shared to the meeting stage from contexts which are outside of the context of the meeting stage.

Share controls which are embedded into the user interface elements and app content of the collaboration client may be programmed to generate a share activation signal in response to activation of the share control. Share controls can be activated by clicking on the share control with a mouse. The share activation signal identifies the content to be shared, e.g., by specifying the URL of the content in which it is embedded. If there is an online collaboration currently being held in the meeting stage, the content is shared to the collaboration. In some implementations, if there is no online collaboration in the meeting stage, the collaboration client can create a new collaboration to which the content can then be shared. Once the content has been shared to the new collaboration, the user can select participants and settings for the new collaboration.

In various implementations, share controls may be created using predefined share control templates. Share control templates can include HTML code which defines the structure, properties, and behavior of share controls. The share control templates may also provide guidance for how to add share controls to the HTML code used to define the user interface elements of the collaboration client and the HTML code which defines the app content loaded into iFrames in the user interface of the collaboration client. Templates make it easier for developers to embed share controls in various contexts outside of the context of the meeting stage.

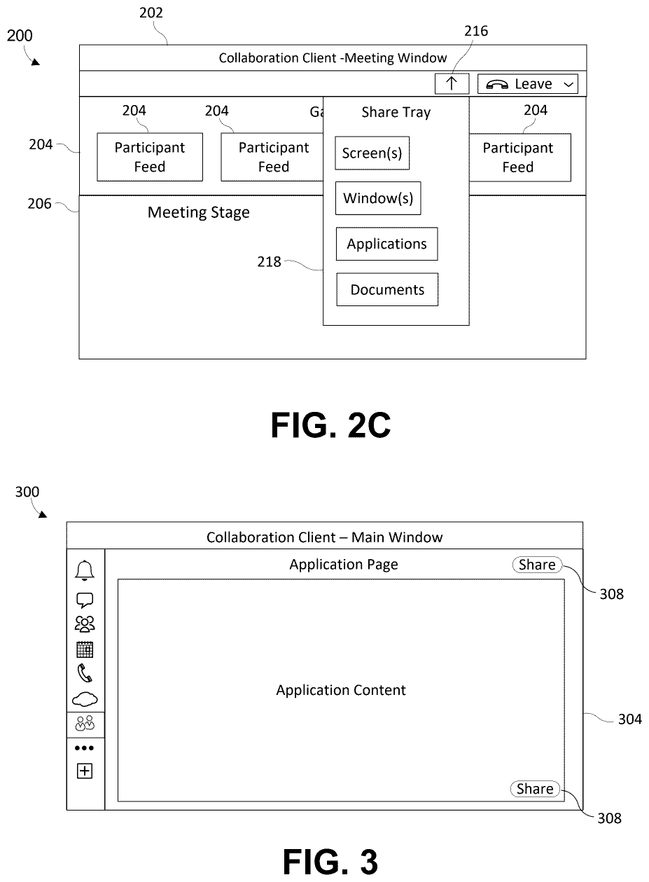

The collaboration and communication platform also provides multiple mechanism which can be used by developers to specify the sharing protocol to use when sharing content to the meeting stage. One such method involves extending the app manifests used for app integration to include properties which indicate the sharing protocol to use to share content from an app to meeting stage. For example, the collaboration and communication platform can include a context property in the app manifests used for app integration that enables developers to indicate that interactive sharing is enabled for the app in the meeting stage. Examples of how a context property in an app manifest for an app can be used to indicate different sharing protocol to use to share content from the app are shown in FIGS. 4A and 4B. The context property defines the contexts of the collaboration client that content from an app can be loaded into. To enable interactive sharing of content to the meeting stage for an application, the app manifest for the application can list the “meetingStage” in the context property of the app manifest, as shown in FIG. 4A. When a share activation signal is received from a share control embedded into an application, the app manifest for the application can be checked to see if “meetingStage” is included in the context property of the app manifest. If meetingStage is included in the context property of the app manifest, the system knows that the interactive sharing protocol can be used to share content from the application to the meeting stage. Conversely, if meetingStage is not included in the context property of the app manifest as shown in FIG. 4B, the system knows to use the non-interactive sharing protocol to share content from the application to the meeting stage. Developers can therefore specify the sharing protocol to use with their apps by including or not including meetingStage in the context property of the app manifest for the application, depending on which sharing protocol the developer would prefer for the system use.

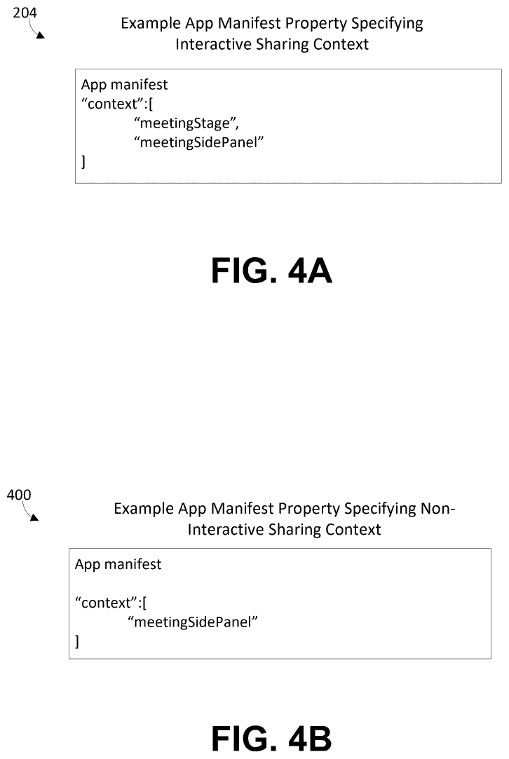

An example implementation of a sharing system 500 that enables a sharing protocol to be specified using app manifests is shown in FIG. 5. The sharing system 500 of FIG. 5 includes a sharing engine 508 which detects when a share control 502 embedded in application content 504 of an application 506 has been activated (e.g. clicked on). For example, in some implementations, the share control is programmed to generate a share activation signal which identifies the URL of the content to be shared. In other implementations, the sharing engine retrieves the URL from the share control in response to activation of the share control. In any event, once the share control has been activated, the sharing engine retrieves the content from the URL. To this end, the sharing engine 508 includes a content retrieval component 510 which retrieves the app content from the application with reference to the URL of the application. The sharing engine 508 also includes an app manifest checking component 512 which accesses the app manifest 514 of the application 506 to identify the sharing contexts included in the app manifest. The sharing engine 508 also includes an interactive sharing component 516 and a non-interactive sharing component 518 which can implement the sharing protocol specified in the app manifest 514 for the application 506 to check the context and permission properties for the application. If the app manifest 514 includes the meetingStage in the context property, the sharing engine uses the interactive sharing component 516 to share the content to the collaboration clients 520 associated with the participants of an online collaboration. If the app manifest 514 does not specify the meetingStage in the context property, the sharing engine 508 uses the non-interactive sharing component 518 to share the content to the collaboration clients 520 associated with the participants of an online collaboration.

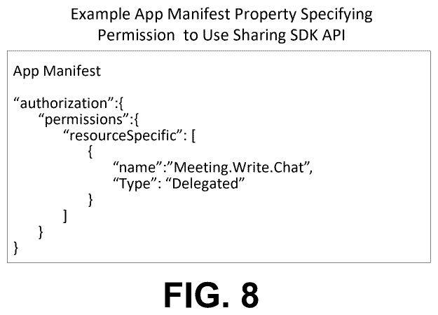

A collaboration and communication platform may require that applications obtain permission to utilize system resources, e.g., APIs, SDKs, and the like, to share their content on the platform. For example, a collaboration and communication platform may require that an application obtain resource-specific consent (RSC) permissions which indicate that the application has permission to use the sharing API(s) of the platform. RSC permissions may be obtained by adding an RSC permission to the authorization property of the app manifest for an application. FIG. 8 shows an example of how to configure the authorization property of an app manifest for an application, and in particular, the “name” and “type” for the resourceSpecific field in the authorization property to obtain RSC permissions for the application. In this example, the string “MeetingStage.Write.Chat” is added to the “name” in the resourceSpecific field to indicate that the application has RSC permissions to use the sharing SDK API. In other implementations, permission to use sharing resources, such as the sharing SDK API, can be granted in any suitable manner. The manifest checking component 512 may be configured to check the app manifest 514 to determine if the application has the appropriate permissions, such as RSC permissions. In this case, if the application has the appropriate permissions to share content on the platform, the sharing engine will proceed with sharing the content to the online collaboration using the sharing protocol indicated by the manifest 514. Otherwise, the sharing engine will not allow the content to be shared to the online collaboration. The sharing engine may cause a notification or alert to be generated to indicate that the application does not have the permissions needed to share content on the platform.

In addition to the predefined share controls described above, the collaboration and communication platform 102 in accordance with this disclosure provides another entry point which enables app content to be selected and shared using a single action from outside the context of the meeting stage. This entry point is enabled via a sharing SDK API for the collaboration and communication platform which defines functions, function calls, commands, parameters, and the like for making API calls to the collaboration and communication platform, and in particular capable of specifying the sharing protocol to use to share content. The sharing SDK API enables developers to create developer defined share controls that are programmed to generate API calls which can be used to activate sharing, identifying the app content to share, and specifying the sharing protocol for the platform to use to share the app content. These API-based share controls are capable of being embedded in app content in the same manner as the share controls 302, 308 shown in FIG. 3. API-based share controls are also capable of selecting and sharing parts of applications, referred to herein as “content items.” Content items can include videos, images, interactive tables, graphs, webpage components, and the like.

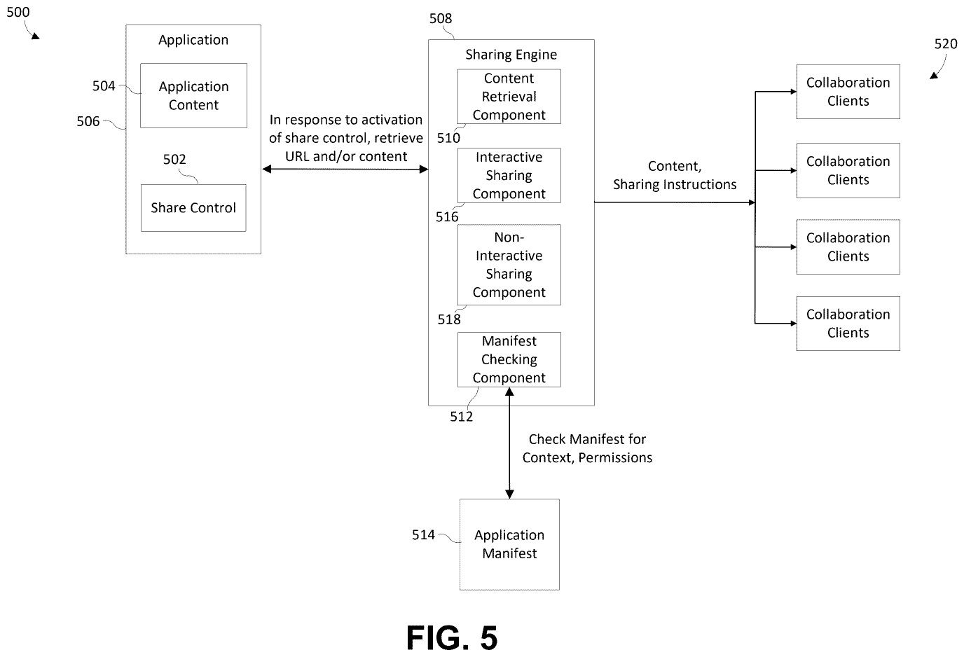

API-based share controls enable multiple share controls to be embedded into an application in association with different content items, and the share controls can be programmed to generate an API call that identifies the content item to share and specifies the sharing protocol to use to share the content item. For example, FIG. 6 shows a third-party application 600 that has an application page with a plurality of content items 604 (e.g., videos). API-based share controls 602 are embedded in the application page in association with each content item 604. When a share control 602 is activated, the share control is programmed to generate an API call which identifies the content item to be shared and specifies a sharing protocol to use to share the content item to an online collaboration. In the example of FIG. 6, the share control associated with content item 1 has been activated and content item 1 (e.g., a video) is shared to the meeting stage 608 of the collaboration client 608. Share controls for different content items can specify different sharing protocols to use to share the content items to the meeting stage. The API calls generated by the share controls 602 can identify the content item to share in any suitable manner. The content item identifier may comprise a URL. In some implementations, content items may be identified and retrieved using predefined deep links to the content item. A deep link is a type of hyperlink that links to a specific page, page element(s), or page content within an app, instead of the homepage of the app.

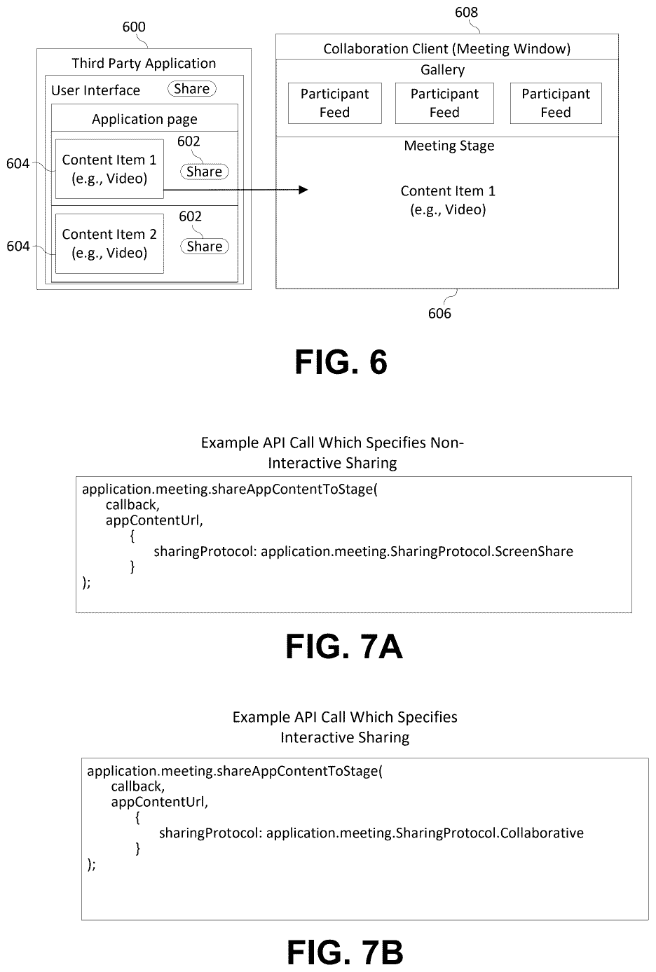

API calls can include recipient identifier if necessary to ensure that API call is directed to an API handling component of the collaboration and communication platform. The recipient identifier can comprise a unique name, address, handle, or the like. Example implementations of API calls which can be used to specify app content to share and the sharing protocol to use to share the app content are shown in FIGS. 7A and 7B. In this example, the name appContentUrl represents the URL of the application or app content that is to be shared. The sharing SDK API defines how sharing options, such as sharing protocol, can be specified in an API call. In this example, the sharing protocol is specified using a sharingProtocol statement which includes a predefined term for indicating the sharing protocol to use. FIG. 7A shows the API call for specifying the non-interactive sharing protocol, and FIG. 7B shows the API call for specifying the interactive sharing protocol. In the example of FIG. 7A, the term “ScreenShare” is used to indicate that the non-interactive sharing protocol is to be used to share content from the application, and, in the example of FIG. 7B, the term “Collaborative” is used to indicate that the interactive sharing protocol is to be used to share content from the application. In other implementations, any suitable predefined terminology may be used to specify the sharing protocol in the API call.

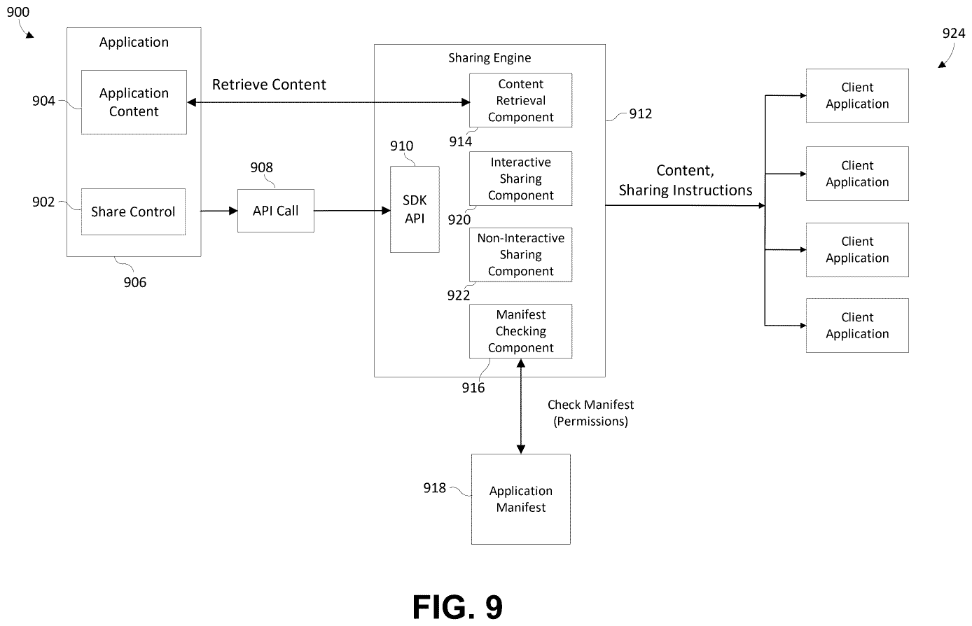

FIG. 9 shows an example implementation of a sharing system 900 that that uses an API-based share control 902 embedded in app content 904 of an application 906 to generate an API call 908 that identifies the app content to share and specifies the sharing protocol to use to share the content.to an online collaboration. The API call 908 identifies the app content to share, for example, using a URL of the application. The API call 908 is received by an SDK API 910 of the sharing engine 912. The sharing engine 912 includes a content retrieval component 914 which retrieves the app content 904 from the URL indicated by the API call 908. The sharing engine 912 also includes an app manifest checking component 916 which accesses the app manifest 918 of the application 906 to check to see if the App manifest includes the appropriate RSC permissions indicating that the application 906 has permission to use the sharing SDK API to share content to the meeting stage. The sharing engine 912 also includes an interactive sharing component 920 and a non-interactive sharing component 922 which can implement the sharing protocol specified in the API call 908 to cause the app content to be shared to the meeting stage of the collaboration clients 924 which are associated with the participants of an online collaboration to which the content is to be shared.

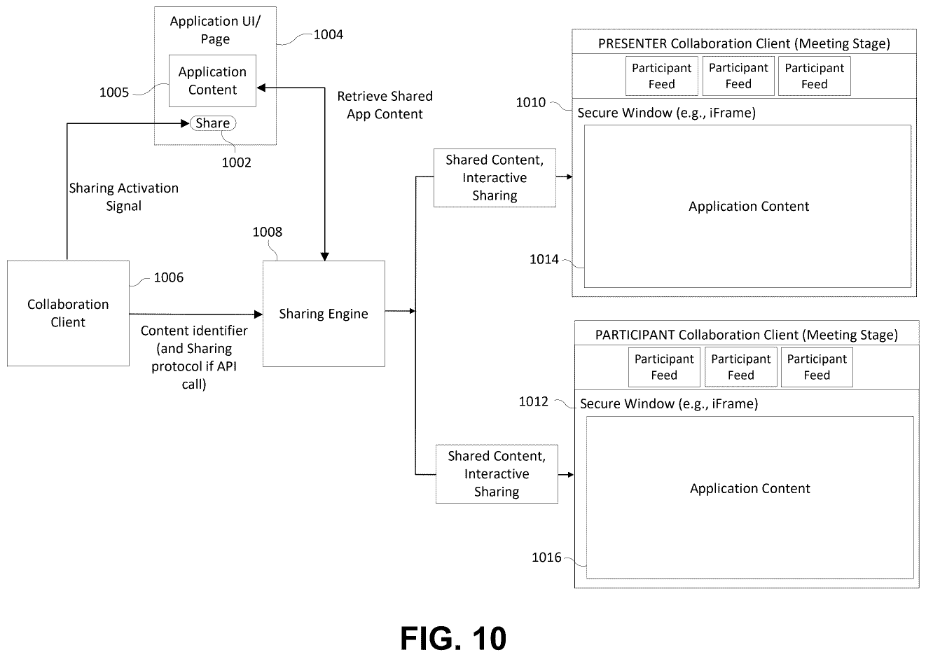

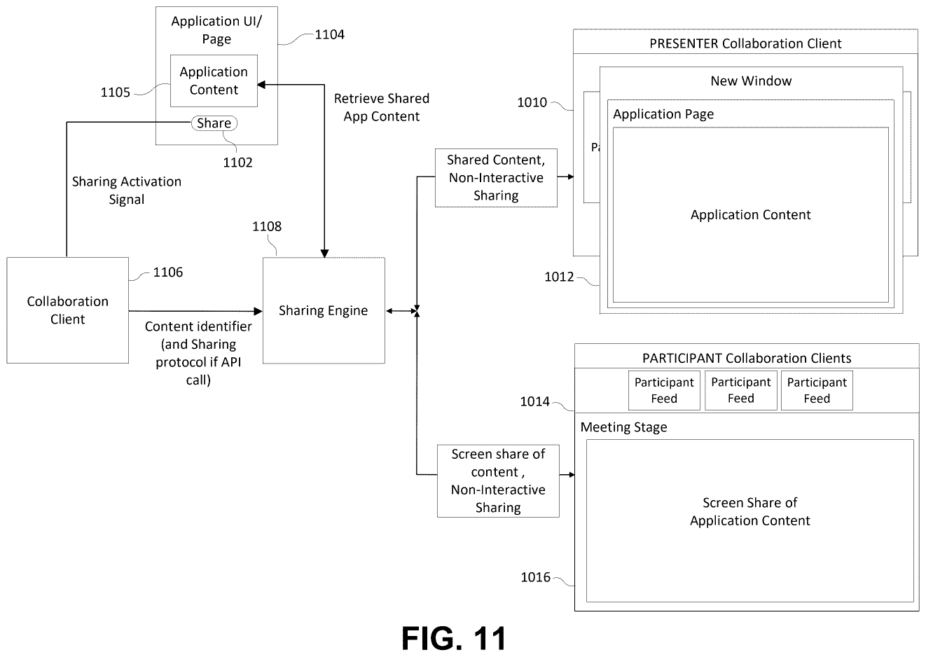

FIGS. 10 and 11 depict block diagrams for demonstrating how interactive and non-interactive sharing protocols may be implemented, respectively, for the collaboration and communication platform. Referring to FIG. 10, a share control 1002 is added to the application UI and/or the application page 1004 to enable application content 1005 to be shared to an online collaboration. In some implementations, the share control 1002 is provided by the platform and embedded in the UI. In other implementations, the share control 1002 is provided by the developer and embedded in the application page. In response to activation of the share control 1002, a sharing activation signal or an API call (depending on the implementation of the share control) is transmitted to the collaboration client 1006 which indicates the content to be shared. The collaboration client 1006 in turn communicates a content identifier for the content to a sharing engine 1008. The sharing engine retrieves the app content 1005 associated with the share control. If an API call is used, the sharing protocol specified by the API call is also transmitted to the sharing engine 1008. If an API call is not used, the sharing engine 1008 determines the sharing protocol to use for the app content from the app manifest of the application associated with the app content 1004. The sharing engine 1008 retrieves the app content 1004 using the content identifier. The sharing engine 1008 implements the interactive sharing protocol by instructing the collaboration clients associated with the presenter 1010 and the other participants 1012 of the online collaboration to load the application content into a secure interface 1014, 1016, such as an iFrame, in the meeting stage of each the collaboration clients 1010, 1012. In this example, the provider of the application content has enabled the application content to be opened and edited by multiple users at the same time and to synchronize changes across all copies of the application content loaded into the meeting stage at each collaboration client.

Referring to FIG. 11, a share control 1102 is added to the application UI and/or the application page 1104 to enable application content 1105 to be shared to an online collaboration. In some implementations, the share control 1102 is provided by the platform and embedded in the UI. In other implementations, the share control 1102 is provided by the developer and embedded in the application page. In response to activation of the share control 1002, associated with application content 1105 to be shared is activated which causes the share control 1102 to transmit a sharing activation signal to the collaboration client 1106. In some implementations, the collaboration client 1106 retrieves the URL for the content 1105 from the share control. In other implementations, the sharing activation signal includes an API call which identifies the URL of the content to be shared. The collaboration client 1106 may provide a content identifier (e.g., URL) associated with the app content 1104 to the sharing engine 1108. If an API call is used, the sharing protocol specified by the API call is also transmitted to the sharing engine 1108. If an API call is not used, the sharing engine 1108 determines the sharing protocol to use for the app content from the app manifest of the application associated with the app content 1104. The sharing engine 1108 retrieves the app content 1104 using the content identifier. In this example, non-interactive sharing is implemented by instructing the collaboration client 1010 associated with the participant that is sharing content to load the shared content in a new window 1012 and share a screen share of the new window to the sharing engine 1108. The screen share of the shared content is delivered to the collaboration clients 1014 associated with the other participants of the online collaboration and presented to the online collaboration in the meeting stage 1016 of the collaboration clients 1014.

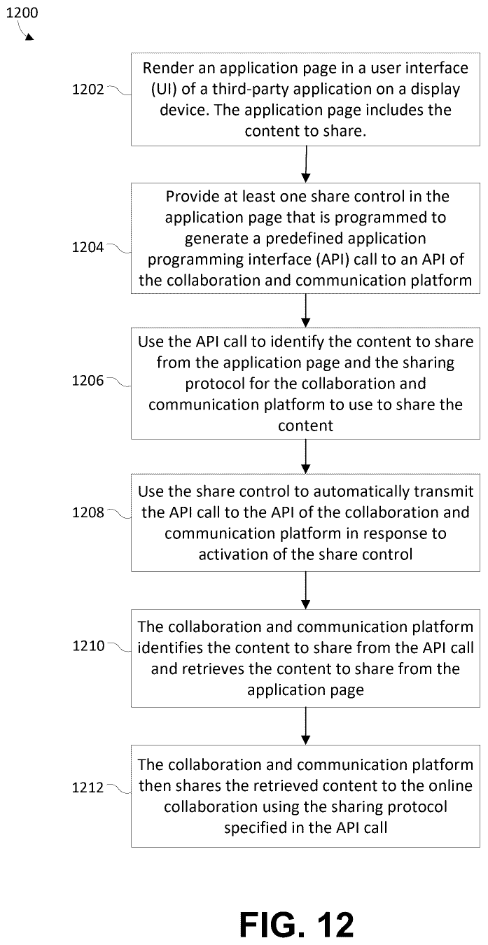

FIG. 12 depicts a flowchart of an example method 1200 for sharing application content from a third-party application to an online collaboration hosted by a collaboration and communication platform. The method begins with rendering an application page in a user interface (UI) of the third-party application on a display device (block 1202). The application page includes the application content to share, and the third-party application is associated with a first user. At least one share control is provided in the application page that is programmed to generate a predefined application programming interface (API) call to an API of the collaboration and communication platform (block 1204). The API call (i) identifies the application content to share to the online collaboration, and (ii) specifies a sharing protocol for the collaboration and communication platform to use to share the application content to the online collaboration (block 1206). The sharing protocol is one of a plurality of different sharing protocols enabled by the collaboration and communication platform. Each of the sharing protocols defines programmable rules for identifying data to be shared, retrieving the data to be shared, communicating the data to be shared to and from the collaboration and communication platform, and presenting the data to be shared in collaboration clients of the collaboration and communication platform. In response to activation of a share control in the application page, the API call programmed into the at least one share control is transmitted to an API of the collaboration and communication platform (block 1208). The API call causes the collaboration and communication platform to retrieve the content that is to be shared (block 1210). The API call also causes the collaboration and communication platform to share the retrieved content to the online collaboration using the sharing protocol specified in the API call (block 1212).

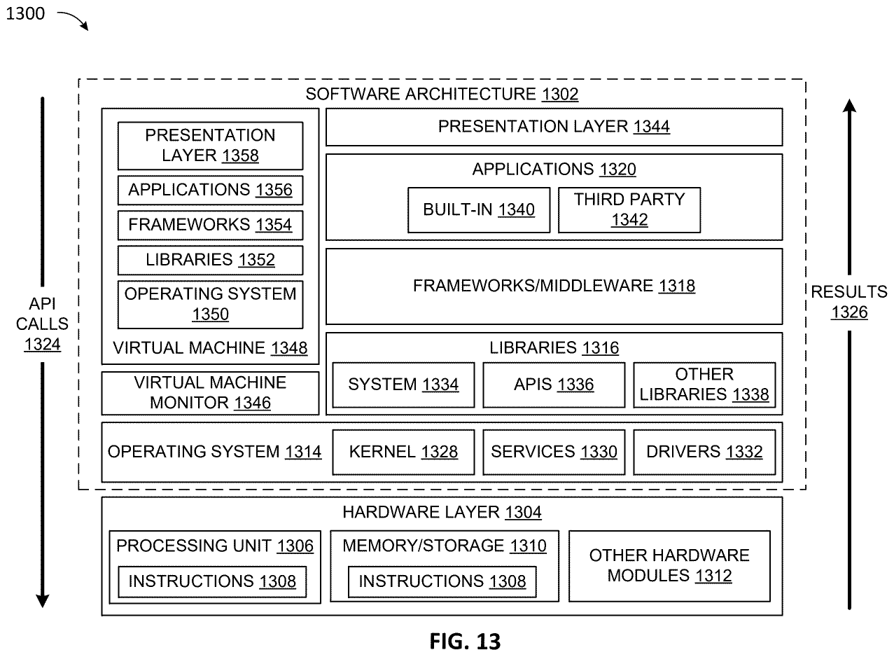

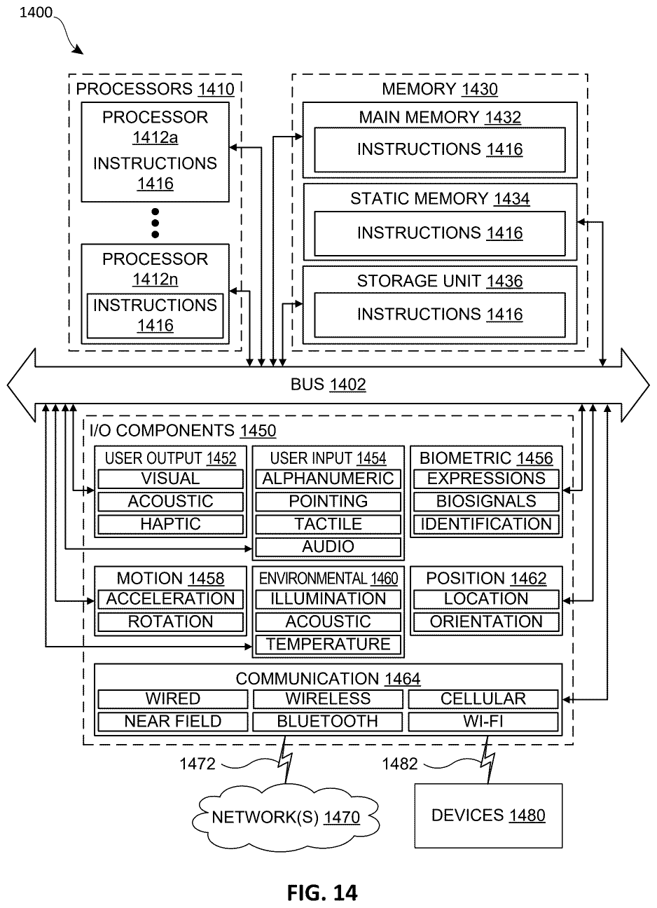

FIG. 13 is a block diagram 1300 illustrating an example software architecture 1302, various portions of which may be used in conjunction with various hardware architectures herein described, which may implement any of the above-described features. FIG. 13 is a non-limiting example of a software architecture, and it will be appreciated that many other architectures may be implemented to facilitate the functionality described herein. The software architecture 1302 may execute on hardware such as a machine 1400 of FIG. 14 that includes, among other things, processors 1410, memory 1430, and input/output (I/O) components 1450. A representative hardware layer 1304 is illustrated and can represent, for example, the machine 1400 of FIG. 14. The representative hardware layer 1304 includes a processing unit 1306 and associated executable instructions 1308. The executable instructions 1308 represent executable instructions of the software architecture 1302, including implementation of the methods, modules and so forth described herein. The hardware layer 1304 also includes a memory/storage 1310, which also includes the executable instructions 1308 and accompanying data. The hardware layer 1304 may also include other hardware modules 1312. Instructions 1308 held by processing unit 1306 may be portions of instructions 1308 held by the memory/storage 1310.

The example software architecture 1302 may be conceptualized as layers, each providing various functionality. For example, the software architecture 1302 may include layers and components such as an operating system (OS) 1314, libraries 1316, frameworks 1318, applications 1320, and a presentation layer 1344. Operationally, the applications 1320 and/or other components within the layers may invoke API calls 1324 to other layers and receive corresponding results 1326. The layers illustrated are representative in nature and other software architectures may include additional or different layers. For example, some mobile or special purpose operating systems may not provide the frameworks/middleware 1318.

The OS 1314 may manage hardware resources and provide common services. The OS 1314 may include, for example, a kernel 1328, services 1330, and drivers 1332. The kernel 1328 may act as an abstraction layer between the hardware layer 1304 and other software layers. For example, the kernel 1328 may be responsible for memory management, processor management (for example, scheduling), component management, networking, security settings, and so on. The services 1330 may provide other common services for the other software layers. The drivers 1332 may be responsible for controlling or interfacing with the underlying hardware layer 1304. For instance, the drivers 1332 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1316 may provide a common infrastructure that may be used by the applications 1320 and/or other components and/or layers. The libraries 1316 typically provide functionality for use by other software modules to perform tasks, rather than interacting directly with the OS 1314. The libraries 1316 may include system libraries 1334 (for example, C standard library) that may provide functions such as memory allocation, string manipulation, and file operations. In addition, the libraries 1316 may include API libraries 1336 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1316 may also include a wide variety of other libraries 1338 to provide many functions for applications 1320 and other software modules.

The frameworks 1318 (also sometimes referred to as middleware) provide a higher-level common infrastructure that may be used by the applications 1320 and/or other software modules. For example, the frameworks 1318 may provide various graphic user interface (GUI) functions, high-level resource management, or high-level location services. The frameworks 1318 may provide a broad spectrum of other APIs for applications 1320 and/or other software modules.

The applications 1320 include built-in applications 1340 and/or third-party applications 1342. Examples of built-in applications 1340 may include, but are not limited to, a contacts application, a browser application, a location application, a media application, a messaging application, and/or a game application. Third-party applications 1342 may include any applications developed by an entity other than the vendor of the particular platform. The applications 1320 may use functions available via OS 1314, libraries 1316, frameworks 1318, and presentation layer 1344 to create user interfaces to interact with users.

Some software architectures use virtual machines, as illustrated by a virtual machine 1348. The virtual machine 1348 provides an execution environment where applications/modules can execute as if they were executing on a hardware machine (such as the machine 1400 of FIG. 14, for example). The virtual machine 1348 may be hosted by a host OS (for example, OS 1314) or hypervisor, and may have a virtual machine monitor 1346 which manages operation of the virtual machine 1348 and interoperation with the host operating system. A software architecture, which may be different from software architecture 1302 outside of the virtual machine, executes within the virtual machine 1348 such as an OS 1350, libraries 1352, frameworks 1354, applications 1356, and/or a presentation layer 1358.

FIG. 14 is a block diagram illustrating components of an example machine 1400 configured to read instructions from a machine-readable medium (for example, a machine-readable storage medium) and perform any of the features described herein. The example machine 1400 is in a form of a computer system, within which instructions 1416 (for example, in the form of software components) for causing the machine 1400 to perform any of the features described herein may be executed. As such, the instructions 1416 may be used to implement modules or components described herein. The instructions 1416 cause unprogrammed and/or unconfigured machine 1400 to operate as a particular machine configured to carry out the described features. The machine 1400 may be configured to operate as a standalone device or may be coupled (for example, networked) to other machines. In a networked deployment, the machine 1400 may operate in the capacity of a server machine or a client machine in a server-client network environment, or as a node in a peer-to-peer or distributed network environment. Machine 1400 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1400 is illustrated, the term “machine” includes a collection of machines that individually or jointly execute the instructions 1416.

The machine 1400 may include processors 1410, memory 1430, and I/O components 1450, which may be communicatively coupled via, for example, a bus 1402. The bus 1402 may include multiple buses coupling various elements of machine 1400 via various bus technologies and protocols. In an example, the processors 1410 (including, for example, a central processing unit (CPU), a graphics processing unit (GPU), a neural processing unit (NPU), a digital signal processor (DSP), an ASIC, or a suitable combination thereof) may include one or more processors 1412a to 1112n that may execute the instructions 1416 and process data. In some examples, one or more processors 1410 may execute instructions provided or identified by one or more other processors 1410. The term “processor” includes a multi-core processor including cores that may execute instructions contemporaneously. Although FIG. 14 shows multiple processors, the machine 1400 may include a single processor with a single core, a single processor with multiple cores (for example, a multi-core processor), multiple processors each with a single core, multiple processors each with multiple cores, or any combination thereof. In some examples, the machine 1400 may include multiple processors distributed among multiple machines.

The memory/storage 1430 may include a main memory 1432, a static memory 1434, or other memory, and a storage unit 1436, both accessible to the processors 1410 such as via the bus 1402. The storage unit 1436 and memory 1432, 1434 store instructions 1416 embodying any one or more of the functions described herein. The memory/storage 1430 may also store temporary, intermediate, and/or long-term data for processors 1410. The instructions 1416 may also reside, completely or partially, within the memory 1432, 1434, within the storage unit 1436, within at least one of the processors 1410 (for example, within a command buffer or cache memory), within memory at least one of I/O components 1450, or any suitable combination thereof, during execution thereof. Accordingly, the memory 1432, 1434, the storage unit 1436, memory in processors 1410, and memory in I/O components 1450 are examples of machine-readable media.

As used herein, “machine-readable medium” refers to a device able to temporarily or permanently store instructions and data that cause machine 1400 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1416) for execution by a machine 1400 such that the instructions, when executed by one or more processors 1410 of the machine 1400, cause the machine 1400 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1450 may include a wide variety of hardware components adapted to receive input, provide output, produce output, transmit information, exchange information, capture measurements, and so on. The specific I/O components 1450 included in a particular machine will depend on the type and/or function of the machine. For example, mobile devices such as mobile phones may include a touch input device, whereas a headless server or IoT device may not include such a touch input device. The particular examples of I/O components illustrated in FIG. 14 are in no way limiting, and other types of components may be included in machine 1400. The grouping of I/O components 1450 are merely for simplifying this discussion, and the grouping is in no way limiting. In various examples, the I/O components 1450 may include user output components 1452 and user input components 1454. User output components 1452 may include, for example, display components for displaying information (for example, a liquid crystal display (LCD) or a projector), acoustic components (for example, speakers), haptic components (for example, a vibratory motor or force-feedback device), and/or other signal generators. User input components 1454 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1450 may include biometric components 1456, motion components 1458, environmental components 1460, and/or position components 1462, among a wide array of other physical sensor components. The biometric components 1456 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1458 may include, for example, acceleration sensors (for example, an accelerometer) and rotation sensors (for example, a gyroscope). The environmental components 1460 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1462 may include, for example, location sensors (for example, a Global Position System (GPS) receiver), altitude sensors (for example, an air pressure sensor from which altitude may be derived), and/or orientation sensors (for example, magnetometers).

The I/O components 1450 may include communication components 1464, implementing a wide variety of technologies operable to couple the machine 1400 to network(s) 1470 and/or device(s) 1480 via respective communicative couplings 1472 and 1482. The communication components 1464 may include one or more network interface components or other suitable devices to interface with the network(s) 1470. The communication components 1464 may include, for example, components adapted to provide wired communication, wireless communication, cellular communication, Near Field Communication (NFC), Bluetooth communication, Wi-Fi, and/or communication via other modalities. The device(s) 1480 may include other machines or various peripheral devices (for example, coupled via USB).

In some examples, the communication components 1464 may detect identifiers or include components adapted to detect identifiers. For example, the communication components 1464 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 1464, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for sharing application content from a third-party application to an online collaboration hosted by a collaboration and communication platform, the data processing system comprising:
a processor; and
a memory storing executable instructions that, when executed, cause the processor alone or in combination with other processors to perform acts of:
rendering an application page in a user interface (UI) of the third-party application on a display device, the application page including the application content to share, the third-party application being associated with a first user;
providing at least one share control in the application page, the at least one share control being programmed to generate an application programming interface (API) call to an API of the collaboration and communication platform, the API call specifying (i) the application content to share to the online collaboration and (ii) a sharing protocol for the collaboration and communication platform to use to share the application content to the online collaboration, the sharing protocol being one of a plurality of different sharing protocols enabled by the collaboration and communication platform, each of the sharing protocols defining a format for how the collaboration and communication platform presents shared content on devices of users attending online collaborations; and
in response to detecting an activation of the at least one share control in the application page:
automatically identifying the API call programmed in the at least one share control; and
causing the collaboration and communication platform to (i) retrieve the application content and (ii) share the retrieved application content to the online collaboration according to the specified sharing protocol by transmitting the API call to the collaboration and communication platform.

2. The data processing system of claim 1, wherein:
the plurality of different sharing protocols includes an interactive sharing protocol and a non-interactive sharing protocol,
for the interactive sharing protocol, a collaboration client associated with the first user and collaboration clients of the collaboration and communication platform associated with other users that are participating in the online collaboration each load the application content in a secure interface element in a meeting stage of their respective collaboration clients in a manner that enables the application content to be interacted with and manipulated in response to user input received via the collaboration clients, wherein interactions and manipulations of the application content performed in the secure interface element at each collaboration client are synchronized and applied to the application content loaded into the secure interface element in the meeting stage of each of the other collaboration clients connected to the online collaboration, and
for the non-interactive sharing protocol, the collaboration client associated with the first user loads the application content into a new window of the collaboration client that is separate from the meeting stage and transmits a screen share of the new window to the collaboration and communication platform which in turn distributes the screen share to the collaboration clients associated with the other users that are participating in the online collaboration, the screen share being presented in the meeting stage of the collaboration clients associated with the other users.

3. The data processing system of claim 2, wherein:
the API call specifies a content item of the application page having the application content to be shared,
for the interactive sharing protocol, the collaboration client associated with the first user and the collaboration clients associated with the other users that are participating in the online collaboration each load only the content item specified by the API call in the secure interface element in the meeting stage, and
for the non-interactive sharing protocol, the collaboration client associated with the first user loads only the content item into the new window of the collaboration client such that the screen share shows a view of only the page element to the online collaboration.

4. The data processing system of claim 1, wherein:
the collaboration and communication platform checks an app manifest associated with the third-party application for a resource-specific consent (RSC) permission.

5. The data processing system of claim 1, wherein:
the API call is received by a collaboration client of the collaboration and communication platform;
in response to receiving the API call, the collaboration client determines whether the online collaboration is available to be shared to,
in response to the collaboration client determining that the online collaboration is available, the collaboration client causes the application content to be shared to the online collaboration using the sharing protocol specified in the API call, and
in response to determining that the online collaboration is not available to be shared to, the collaboration client performs a new collaboration creation process.

6. The data processing system of claim 1, wherein:
the application page includes a plurality of different content items in the application content, and
the at least one share control includes a plurality of share controls, each share control being associated with a different content item and being programmed to generate an API call to the API of the collaboration and communication platform that specifies (i) the content item to be shared and (ii) the sharing protocol to use to share the content item.

7. The data processing system of claim 1, wherein:
the API call includes a recipient identifier which identifies an API handling component of the collaboration and communication platform to direct the API call to.

8. The data processing system of claim 1, wherein:
the application content is specified in the API call using a deep link.

9. A method for sharing application content from a third-party application to an online collaboration hosted by a collaboration and communication platform, the method comprising:
rendering an application page in a user interface (UI) of the third-party application on a display device, the application page including the application content to share, the third-party application being associated with a first user;
providing at least one share control in the application page, the at least one share control being programmed to generate an application programming interface (API) call to an API of the collaboration and communication platform, the API call specifying (i) the application content to share to the online collaboration and (ii) a sharing protocol for the collaboration and communication platform to use to share the application content to the online collaboration, the sharing protocol being one of a plurality of different sharing protocols enabled by the collaboration and communication platform, each of the sharing protocols defining a format for how the collaboration and communication platform presents shared content on devices of users attending online collaborations; and
in response to detecting an activation of the at least one share control in the application page:
automatically identifying the API call programmed in the at least one share control; and
causing the collaboration and communication platform to (i) retrieve the application content and (ii) share the retrieved application content to the online collaboration according to the specified sharing protocol by transmitting the API call to the collaboration and communication platform.

10. The method of claim 9, wherein:
the plurality of different sharing protocols includes an interactive sharing protocol and a non-interactive sharing protocol,
for the interactive sharing protocol, a collaboration client associated with the first user and collaboration clients of the collaboration and communication platform associated with other users that are participating in the online collaboration each load the application content in a secure interface element in a meeting stage of their respective collaboration clients in a manner that enables the application content to be interacted with and manipulated in response to user input received via the collaboration clients, wherein interactions and manipulations of the application content performed in the secure interface element at each collaboration client are synchronized and applied to the application content loaded into the secure interface element in the meeting stage of each of the other collaboration clients connected to the online collaboration, and
for the non-interactive sharing protocol, the collaboration client associated with the first user loads the application content into a new window of the collaboration client that is separate from the meeting stage and transmits a screen share of the new window to the collaboration and communication platform which in turn distributes the screen share to the collaboration clients associated with the other users that are participating in the online collaboration, the screen share being presented in the meeting stage of the collaboration clients associated with the other users.

11. The method of claim 10, wherein:
the API call specifies a content item of the application page having the application content to be shared,
for the interactive sharing protocol, the collaboration client associated with the first user and the collaboration clients associated with the other users that are participating in the online collaboration each load only the content item specified by the API call in the secure interface element in the meeting stage, and
for the non-interactive sharing protocol, the collaboration client associated with the first user loads only the content item such that the screen share shows a view of only the page element to the online collaboration.

12. The method of claim 9, wherein:
the collaboration and communication platform checks an app manifest associated with the third-party application for a resource-specific consent (RSC) permission indicating that the third-party application has permission to use the API.

13. The method of claim 9, wherein:
the API call is received by a collaboration client of the collaboration and communication platform;
in response to receiving the API call, the collaboration client determines whether the online collaboration is available to be shared to,
in response to the collaboration client determining that the online collaboration is available, the collaboration client causes the application content to be shared to the online collaboration using the sharing protocol specified in the API call, and
in response to determining that the online collaboration is not available to be shared to, the collaboration client performs a new collaboration creation process.

14. The method of claim 9, wherein:
the application page includes a plurality of different content items in the application content, and
the at least one share control includes a plurality of share controls, each share control being associated with a different content item and being programmed to generate an API call to the API of the collaboration and communication platform that specifies (i) the content item to be shared and (ii) the sharing protocol to use to share the content item.

15. The method of claim 9, wherein:
the API call includes a recipient identifier which identifies an API handling component of the collaboration and communication platform to direct the API call to.

16. The method of claim 9, wherein:
the application content is specified in the API call using a deep link.

17. A non-transitory computer readable medium on which are stored instructions that, when executed, cause a programmable device to perform functions of:
rendering an application page in a user interface (UI) of a third-party application on a display device, the application page including application content to share to an online collaboration hosted by a collaboration and communication platform, the third-party application being associated with a first user;
providing at least one share control in the application page, the at least one share control being programmed to generate an application programming interface (API) call to an API of the collaboration and communication platform, the API call specifying (i) the application content to share to the online collaboration and (ii) a sharing protocol for the collaboration and communication platform to use to share the application content to the online collaboration, the sharing protocol being one of a plurality of different sharing protocols enabled by the collaboration and communication platform, each of the sharing protocols defining a format for how the collaboration and communication platform presents shared content on devices of users attending online collaborations; and
in response to detecting an activation of the at least one share control in the application page:
automatically identifying the API call programmed in the at least one share control; and
causing the collaboration and communication platform to (i) retrieve the application content and (ii) share the retrieved application content to the online collaboration according to the specified sharing protocol by transmitting the API call to the collaboration and communication platform.

18. The non-transitory computer readable medium of claim 17, wherein:
the plurality of different sharing protocols includes an interactive sharing protocol and a non-interactive sharing protocol,
for the interactive sharing protocol, a collaboration client associated with the first user and collaboration clients of the collaboration and communication platform associated with other users that are participating in the online collaboration each load the application content in a secure interface element in a meeting stage of their respective collaboration clients in a manner that enables the application content to be interacted with and manipulated in response to user input received via the collaboration clients, wherein interactions and manipulations of the application content performed in the secure interface element at each collaboration client are synchronized and applied to the application content loaded into the secure interface element in the meeting stage of each of the other collaboration clients connected to the online collaboration, and
for the non-interactive sharing protocol, the collaboration client associated with the first user loads the application content into a new window of the collaboration client that is separate from the meeting stage and transmits a screen share of the new window to the collaboration and communication platform which in turn distributes the screen share to the collaboration clients associated with the other users that are participating in the online collaboration, the screen share being presented in the meeting stage of the collaboration clients associated with the other users.

19. The non-transitory computer readable medium of claim 18, wherein:
the API call specifies a content item of the application page having the application content to be shared,
for the interactive sharing protocol, the collaboration client associated with the first user and the collaboration clients associated with the other users that are participating in the online collaboration each load only the content item specified by the API call in the secure interface element in the meeting stage, and
for the non-interactive sharing protocol, the collaboration client associated with the first user loads only the content item into the new window of the collaboration client such that the screen share shows a view of only the page element to the online collaboration.

20. The non-transitory computer readable medium of claim 17, wherein:
the API call is received by a collaboration client of the collaboration and communication platform;
in response to receiving the API call, the collaboration client determines whether the online collaboration is available to be shared to,
in response to the collaboration client determining that the online collaboration is available, the collaboration client causes the application content to be shared to the online collaboration using the sharing protocol specified in the API call, and
in response to determining that the online collaboration is not available to be shared to, the collaboration client performs a new collaboration creation process.
